(19) United States
(12) Patent Application Publication
(10) Pub. No.: US 2020/0065730 A1
(43) Pub. Date: Feb. 27, 2020

(54) HANDHELD COMMUNICATION DEVICE HAVING AN APP INCORPORATED THEREIN FOR MONITORING AND CONTROLLING ALL OPERATIONS OF A BUSINESS ESTABLISHMENT, AND SYSTEM INCORPORATING MULTIPLE COMMUNICATION DEVICES THEREIN

(71) Applicant: ANUPAM GOVIND, BLOOMINGDALE, IL (US)

(72) Inventor: ANUPAM GOVIND, BLOOMINGDALE, IL (US)

(21) Appl. No.: 16/110,094

(22) Filed: Aug. 23, 2018

(51) Int. Cl. G06Q 10/06; G06Q 50/12; G06F 3/0481

(52) U.S. Cl. CPC G06Q 10/06313; G06F 3/04817; G06Q 50/12; G06Q 10/06316

(57) ABSTRACT

A hand-held communication device which has an APP incorporated therein, as well as a system comprising a plurality of hand-held communication devices wirelessly connected to each other by means of a communication network which comprises a cloud, is disclosed. The APP is provided with innumerable icons, all of which relate to the innumerable material supplies which are required for operating the business, all operations of the business which are utilized to prepare end products in accordance with patron orders, and peripheral services which are required to maintain the business environment properly maintained and clean in accordance with various business regulations. All food preparation personnel are to be provided with the hand-held communication device of the present invention and a multitude of supervisory personnel are also to be provided with such hand-held communication devices, whereby all of the multitude of hand-held communication devices are adapted to be operationally connected to the internet and a suitable cloud network such that all personnel, particularly the supervisory personnel, can have access to the latest updated intelligence and information concerning the status of the various material supplies, operational procedures, and peripheral restaurant services and communicate such data to food preparation personnel so as to ensure that all operations of the business are being performed properly and efficiently.

### FIELD OF THE INVENTION

The present invention relates generally to business operations equipment, and more particularly to a handheld device having an APP incorporated therein for monitoring and controlling all operations of a business establishment.

### BACKGROUND OF THE INVENTION

As any business owner, founder, or manager knows, in order to operate a business properly and efficiently, as well as to foster good will and enhance business patronage, it is critically important for all aspects of the various business operations to be properly controlled and monitored in order to ensure that everything is in fact operating efficiently and in a timely manner so that the multitude of patron orders is achieved in the desired manner. For example, when operating a restaurant, particularly a fast-food restaurant where a relatively large number of patron orders are to be processed within a relatively small period of time, multiple operational and resource or supply operations need to be constantly monitored and controlled. More particularly, in connection with the processing of food orders, such as, for example, hamburgers, French fries, pancakes, and various different drinks, food supplies required for such food menu items are in constant demand. Similarly, the cooking and holding times for the French fries, hamburgers, pancakes, and the like must likewise be constantly monitored and controlled. Of course, conventionally, in connection with various cooking operations being performed, different establishments utilize different conventional timers for different items being prepared, however, the customary practice in the industry is that each piece of food equipment is provided with its own timer, and a member of the food preparation team needs to set the timer for each piece of food equipment. This obviously renders the various pieces of food equipment more expensive, and in addition, requires additional staff personnel to serve upon the food preparation team so as to in fact initiate operation of the food equipment as well as to monitor the operation of the same during the food preparation processes or cooking periods and to terminate predetermined cooking operations. Still yet further, additional staff personnel are required to perform peripheral support operations such as, for example, cleaning of the business premises, the removal of trash, and the like.

Accordingly, a need exists in the art for a new and improved piece of business operations equipment. Another need exists in the art for a new and improved piece of business operations equipment which can monitor and control a multitude of operations essential to the quick, efficient, and accurate operation of a particular business establishment. Still another need exists in the art for a new and improved piece of business operations equipment which can monitor and control a multitude of operations essential to the quick, efficient, and accurate operation of a particular business establishment and wherein the new and improved piece of business operations equipment comprises a hand-held device. Yet another need exists in the art for a new and improved piece of business operations equipment which can monitor and control a multitude of operations essential to the quick, efficient, and accurate operation of a particular business establishment, wherein the new and improved piece of business operations equipment would comprise a hand-held communication device, and wherein the hand-held device would be provided with an APP. Yet still another need exists in the art for a new and improved piece of business operations equipment which can monitor and control a multitude of operations essential to the quick, efficient, and accurate operation of a particular business establishment, wherein the new and improved piece of business operations equipment would comprise a hand-held communication device, wherein the hand-held device would be provided with an APP, and wherein the APP could monitor and effectively control the supply of materials required to operate the business' operations, monitor and control the operations and status of the business' various apparatus or equipment, and monitor and control the operations of the business' various peripheral support operations.

### Overall Objectives of the Invention

Accordingly, an overall objective of the present invention is to provide a new and improved piece of business operations equipment. Another overall objective of the present invention is to provide a new and improved piece of business operations equipment which can monitor and control a multitude of operations essential to the quick, efficient, and accurate operation of a particular business establishment. Still another overall objective of the present invention is to provide a new and improved piece of business operations equipment which can monitor and control a multitude of operations essential to the quick, efficient, and accurate operation of a particular business establishment and wherein the new and improved piece of business operations equipment comprises a hand-held device. Yet another overall objective of the present invention is to provide a new and improved piece of business operations equipment which can monitor and control a multitude of operations essential to the quick, efficient, and accurate operation of a particular business establishment, wherein the new and improved piece of business operations equipment would comprise a hand-held communication device, and wherein the hand-held communication device would be provided with an APP. Yet still another overall objective of the present invention is to provide a new and improved piece of business operations equipment which can monitor and control a multitude of operations essential to the quick, efficient, and accurate operation of a particular business establishment, wherein the new and improved piece of business operations equipment will comprise a hand-held communication device, wherein the hand-held communication device will be provided with an APP, and wherein the APP could monitor and effectively control the supply of materials required to operate the business' operations, monitor and control the operations and status of the business' various apparatus or equipment, and monitor and control the operations of the business' various peripheral support operations.

### SUMMARY OF THE INVENTION

The foregoing and other objectives are achieved in accordance with the principles and teachings of the present invention through the provision of a hand-held communication device which has an APP incorporated therein, as well as a system comprising a plurality of hand-held communication devices wirelessly connected to each other by means of a communication network which comprises a cloud. The APP, in turn, is provided with innumerable icons, all of which relate to the innumerable material supplies which are required for operating the business, all operations of the business which are utilized to prepare end products in accordance with patron orders, and peripheral services which are required to maintain the business environment properly maintained and clean in accordance with various business regulations. More particularly, for example, assuming that the particular business establishment is a fast-food restaurant, then the APP would have innumerable icons incorporated therein which would identify all food items that would be utilized in connection with the preparation of various different food patron orders. Examples of such would be the available supply of hamburger buns, hamburgers, lettuce, onions, pickles, tomatoes, condiments, such as mustard, ketchup, and tartar sauce, pancake batter, butter patties, chicken tenders, French fries, fish filets, milk, English muffins, eggs, cheese slices, various grated cheeses, broccoli, cauliflower, carrots, and the like. In addition, the APP would also be further provided with a multitude of icons which are directed toward various cooking times for individual items, various times at which food preparation must wash their hands or change their gloves which they use to handle food items, how often rest rooms must be cleaned, and how often trash must be discarded from the restaurant. Still yet further, all food preparation personnel are to be provided with the hand-held communication device of the present invention and a multitude of supervisory personnel are also to be provided with such hand-held communication devices, whereby all of the multitude of hand-held communication devices are adapted to be operationally connected to the internet and a suitable cloud network such that all personnel, particularly the supervisory personnel, can have access to the latest updated intelligence and information concerning the status of the various material supplies, operational procedures, and peripheral restaurant services and communicate such data to food preparation personnel so as to ensure that all operations of the business are being performed properly and efficiently.

### BRIEF DESCIRPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a hand-held communication device which has been developed in accordance with the principles and teachings of the present invention wherein it is to be appreciated that the hand-held communication device can comprise, for example, a smart phone, a tablet, or other similar communication device; and

FIG. 2 is a schematic drawing illustrating the use of a multitude of hand-held communication devices, as constructed in accordance with the principles and teachings of the present invention, in connection with each other and as operationally connected to an internet network which includes a cloud so that all hand-held communication devices can access information stored within the cloud and wherein further all of the hand-held communication devices can communicate with each other.

### DETAILED DESCRIPTION OF THE PREFERRED EMBODIMENT

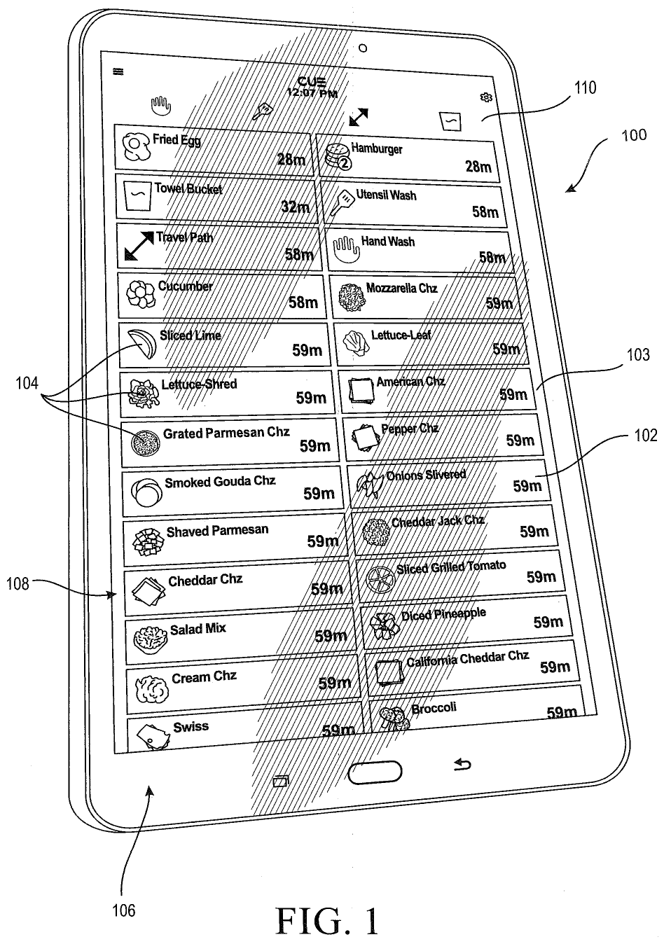

Referring now to the drawings, and more particularly to FIG. 1 thereof, a new and improved hand-held communication device, as constructed in accordance with the principles and teachings of the present invention, is disclosed and is generally indicated by the reference character 100. More particularly, it is seen that the new and improved hand-held communication device 100 effectively comprises a smart phone or a tablet upon or within which a specific APP 102, which has been developed in accordance with the principles and teachings of the present invention, has been incorporated. As has been noted, while the principles and teachings of the present invention permit the hand-held communication device 100 and the APP 102 to be applicable to all business establishments, for the purposes of the present invention disclosure, the hand-held communication device 100 and the APP 102 will be considered in connection with a fast-food restaurant. Accordingly, it is seen that the hand-held communication device 100, having the APP 102 incorporated and displayed upon the face or display screen 103 of the hand-held communication device 100, will comprise a multitude of icons 104 arranged within a grid comprising one or more vertical columns 106 of icons 104 as well as a multitude of horizontal rows 108 of icons 104. In addition, it is also to be noted that different screens of additional icons 104 can be presented to the user or viewer as a result of vertical and horizontal finger swipes as is conventionally used in connection with locating, for example, a particular photo from a multitude of photos stored within conventional hand-held communication devices, smart phones, tablets, or the like. As has been noted hereinbefore, each icon 104 is adapted to represent, for example, any one of a multitude of food items to be used in connection with the preparation of various different patron food orders such as, for example, and without limitation, hamburger buns, hamburgers, lettuce, onions, pickles, tomatoes, condiments, such as mustard, ketchup, and/or tartar sauce, pancake batter, butter patties, chicken tenders, French fries, fish filets, milk, English muffins, eggs, cheese slices, various grated cheeses, broccoli, cauliflower, carrots, and the like, as well as to monitor various different operations peripheral, but necessary, to operating the particular business, such as, for example, the supply of food items to be prepared, the disposal of trash, the cleaning of the restaurant facilities, and the like.

One unique feature of the present invention, as can be seen from FIG. 1, is that the uppermost horizontal row 110 of icons comprises a plurality of icons 104 which may be used as specific icons at any location within the aforenoted grid of icons 104 and may be appropriately labeled so as to enable the user to identify the icon 104 and to thereafter monitor the same. Various other different icons may of course be imported and utilized within the uppermost horizontal row 110 of icons for selective use within the horizontal rows 108 of icons or within the vertical columns 106 of icons. For example, in the upper left corner of the illustrated screen, that is, at the top of the first vertical column 106 of icons, the first icon is labeled FRIED EGG. In a similar manner, in the upper right corner of the illustrated screen, that is, at the top of the second vertical column 106 of icons, the first icon is labeled HAMBURGER. In addition, another second unique feature of the present invention, as can also be seen from FIG. 1, is that adjacent to the FRIED EGG and HAMBURGER icons 104, there is a time period noted, such as, for example, 28 m or 28 minutes. This time period can designate, for example, the maximum period of time that such items should be allowed to effectively be stored, after they have been cooked or prepared, before being utilized in connection with the preparation of a particular food menu item as ordered by a patron. At the expiration of such time period, the food item is to be discarded so as not to be utilized in connection with the preparation of any food menu item as ordered by a patron. This monitoring and control procedure is practiced and enforced so as to ensure that only freshly prepared food items are in fact served to food patrons.

Alternatively still further, a third unique feature of the present invention as may be appreciated from FIG. 1, is that in lieu of the noted time period being utilized as a means for determining, monitoring, and controlling the maximum period of time that such items should be allowed to effectively be stored, after they have been cooked, before being utilized in connection with the preparation of a particular food menu item as ordered by a patron, the time period displayed upon the screen of the hand-held communication device, adjacent to the particular food menu item icon 104, can also be utilized for predetermining, monitoring, and controlling the actual cooking or preparation time for the specific food item. Still yet further, a fourth unique feature of the present invention is that next to the particular icon of, for example, a food item, a number may be provided so as to inform personnel as to the supply of such food items such that the same can be replenished in order that sufficient supplies of the food items may always be maintained so as to always be capable of fulfilling orders of particular food items as ordered by particular food patrons.

Still further, it will be noted, for example, that the sixth icon 104, as considered when moving downwardly from the top of the left vertical column 106, is labeled LETTUCE-SHREDDED, and that a time of 59 m or 59 minutes is noted. Accordingly, a fifth unique feature of the present invention is that this time period may in fact designate the maximum period of time that such items should be allowed to effectively be stored, such as, for example, under refrigerated conditions, before being utilized in connection with the preparation of a particular food menu item as ordered by a patron. At the expiration of such time period, the food item is to be discarded so as not to be utilized in connection with the preparation of any food menu item as ordered by a patron. This monitoring and control procedure is practiced and enforced so as to ensure that only freshly prepared food items are in fact served to food patrons. As can also be seen in FIG. 1, the various different icons 104 displayed upon the screen of the hand-held communication device 100 may include, and without limitation, various different specific food items conventionally utilized within various different, food establishments, such as, for example, fried eggs, scrambled eggs, cucumbers, sliced limes, shredded lettuce, grated parmesan cheese, smoked gouda cheese, mixed salads, cream cheese, Swiss cheese, hamburgers, mozzarella cheese, leaf lettuce, American cheese, pepper cheese, slivered onions, cheddar jack cheese, sliced tomatoes, diced pineapples, California cheese, and broccoli. Other items are of course also readily envisioned, again without limitation such as, for example, milk, cream, potatoes for French fries, chicken strips, chicken tenders, Canadian bacon, sausage, mustard, ketchup, other sauces, fish filets, fountain drinks, coffee, whipped cream, pancake batter, and the like.

Continuing further, a sixth unique feature of the present invention resides in the fact that the new and improved hand-held communication device 100 can be utilized to monitor and control peripheral operations critically important to the successful and continuous operation of the particular business establishment. For example, as can again be seen from FIG. 1, the second icon 104 in the upper portion of the first vertical column 106 is labeled TOWEL BUCKET and has a time icon of 32 m or 32 minutes next to it. This means, for example, that all cleaning, wiping, or drying towels that have been deposited into the towel bucket after they have been used for a cleaning, wiping, or drying operation, must be discarded, that is, the towel bucket taken to, for example, a laundry premises which is located on-site within the restaurant premises, so that the towels may be freshly laundered, and concomitantly, a freshly laundered batch of towels will then be utilized. This procedure obviously ensures that the business establishment remains as clean as possible. In a similar manner, as can also be seen from FIG. 1, the second icon 104 in the upper portion of the second vertical column 106 is labeled UTENSIL WASH and has a time icon of 58 m or 58 minutes next to it. This means, for example, that all utensils that have been deposited into a suitable container, as a result of being collected after food patrons have finished their meals, must be inserted into a dishwasher so as to be properly cleaned and readied for another cyclic use by subsequent patrons in connection with their subsequently ordered menu items. Again, this procedure obviously ensures that the business establishment only provides clean utensils to its food patrons. Still further, another icon may indicate that personnel should wash their hands within predetermined time periods, or change gloves with which they handle food items, or clean tables, or clean the floor, again, all to ensure cleanliness throughout the restaurant.

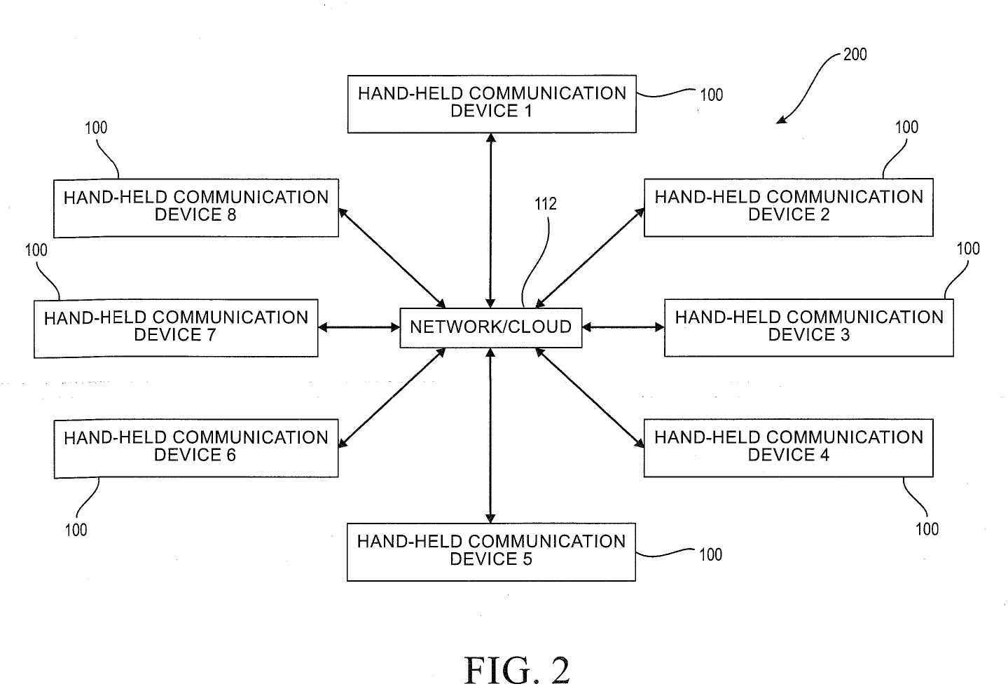

With reference now being made to FIG. 2, a seventh unique feature of the present invention will be appreciated. More particularly, it is seen that a multitude of hand-held communication devices 100 may be utilized together as a result of being linked to each other, as well as to the internet and a suitable cloud system 112 so as to form an interconnected communication system 200. The multitude of hand-held communication devices 100 may be connected to each other and to the internet and cloud system 112 by means of any suitable wifi or other wireless connection, and in this manner, each food preparation team member will be able to input appropriate data in connection with the aforenoted icons so that all other team members will be aware of the up-to-date status concerning particular food items and/or other operations that need to be performed and monitored. In addition, supervisory personnel or managers can likewise maintain or obtain such up-to-date status of the various food preparation and cooking, food supplies, and peripheral operations to be or being performed. This is clearly rendered possible as a result of all personnel having access to the cloud network. It is additionally to be understood that when multiple orders of the same food item are in fact ordered by different food patrons and are being prepared by different food preparation personnel, the icons 104 can be designated differently so as to effectively designate the different food orders. For example, if two food patrons both order cheeseburgers, one icon 104 can be designated as CHEESEBURGER-1 while the other icon 104 can be designated as CHEESEBURGER-2.

Continuing still further, an eighth unique feature of the hand-held communication device 100 constructed in accordance with the principles and teachings of the present invention resides in the fact that since all food supply, food cooking or preparation times, holding or storage times, and the like, are stored within the cloud, various different reports can be generated from such data in order to further monitor the restaurant operations and to ensure that all operations are being conducted with maximum efficiency. These reports can effectively be audit reports, efficiency reports, food supply reports, operational reports detailing the periods of time that is required to prepare different food items, and the like. Still yet further, a ninth unique feature of the hand-held communication device 100 is that it can display the icons and generate the aforenoted reports in several different languages.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100-Hand-held communication device
102-APP of hand-held communication device 100
103-Display screen of hand-held communication device
104-Item icons
106-Vertical columns of icons 104 on display screen 103
108-Horizontal rows of icons 104 on display screen 103
110-Uppermost row of icons 104 from which icons are selected
112-Cloud of system 200
200-Network system established between multitude of hand-held devices 100

What is claimed as new and desired to be protected by Letters Patent, is:

1. A hand-held communication device for monitoring or controlling various operations within a business establishment, comprising:
a hand-held communication device having a display screen; and
an APP incorporated within said hand-held communication device
and displayed upon said display screen,
wherein said APP comprises a multitude of selectively changeable icons which designate various different items to be monitored or controlled so as to ensure that the various operations to be conducted within the business establishment are in fact being conducted properly and within predetermined time periods.

2. The hand-held communication device as set forth in claim 1, wherein:
said hand-held communication device is selected from the group comprising a smart phone, tablet, and the like.

3. The hand-held communication device as set forth in claim 1, wherein:
said multitude of selectively changeable icons are arranged within a grid comprising a plurality of horizontal rows and a plurality of vertical columns displayed upon said display screen of said hand-held communication device.

4. The hand-held communication device as set forth in claim 3, wherein:
the business establishment comprises a restaurant; and
said multitude of selectively changeable icons comprise icons of various different food items to be prepared within the restaurant in accordance with food menu item orders placed by food patrons of the restaurant.

5. The hand-held communication device as set forth in claim 4, wherein:
said multitude of selectively changeable icons indicative of various different food items to be utilized within foods to be prepared comprise pictures of fried eggs, scrambled eggs, cucumbers, sliced limes, shredded lettuce, grated parmesan cheese, smoked gouda cheese, mixed salads, cream cheese, Swiss cheese, hamburgers, mozzarella cheese, leaf lettuce, American cheese, pepper cheese, slivered onions, cheddar jack cheese, sliced tomatoes, diced pineapples, California cheese, broccoli, milk, cream, potatoes for French fries, chicken strips, chicken tenders, Canadian bacon, sausage, mustard, ketchup, other sauces, fish filets, fountain drinks, coffee, whipped cream, pancake batter, and the like.

6. The hand-held communication device as set forth in claim 5, wherein:
said multitude of selectively changeable icons indicative of various different food items to be utilized within foods to be prepared comprise time icons within which time periods the food items are to be prepared.

7. The hand-held communication device as set forth in claim 5, wherein:
said multitude of selectively changeable icons indicative of various different food items to be utilized within foods to be prepared comprise time icons within which time periods the food items are to be utilized so as to ensure freshly prepared food items for the patrons.

8. The hand-held communication device as set forth in claim 5, wherein:
said multitude of selectively changeable icons indicative of various different food items to be utilized within foods to be prepared comprise time icons within which time periods the food items are to be stored under refrigerated conditions so as to ensure freshly prepared food items for the patrons.

9. The hand-held communication device as set forth in claim 3, wherein:
said multitude of selectively changeable icons comprise icons of various different operational procedures to be performed within the business establishment in accordance so as to ensure that the business establishment runs properly and efficiently.

10. The hand-held communication device as set forth in claim 9, wherein:
said multitude of selectively changeable icons comprising icons of various different operational procedures to be performed within the business establishment in accordance so as to ensure that the business establishment runs properly and efficiently is selected from the group comprising the cleaning of utensils, cleaning of tables, discarding trash, food preparation personnel washing their hands or changing gloves within which they handle food items, and the like.

11. A system of hand-held communication devices for monitoring or controlling various operations within a business establishment, comprising:
a plurality of hand-held communication devices having display screens respectively incorporated therein; and
an APP incorporated within each one of said hand-held communication devices and displayed upon said plurality of display screens;
wherein said APP comprises a multitude of selectively changeable icons which designate various different items to be monitored or controlled so as to ensure that the various operations to be conducted within the business establishment are in fact being conducted properly and within predetermined time periods; and
a communication network wirelessly interconnecting said plurality of hand-held communication devices such that establishment personnel can readily communicate with each other as well as monitor or control the various icons representative of various different tasks to be performed within the establishment.

12. The system as set forth in claim 11, wherein:
each one of said hand-held communication devices is selected from the group comprising a smart phone, tablet, and the like.

13. The system as set forth in claim 11, wherein:
said multitude of selectively changeable icons disposed upon each one of said display screens of each one of said hand-held communication devices are arranged within a grid comprising a plurality of horizontal rows and a plurality of vertical columns displayed upon said display screen of said hand-held communication device.

14. The system as set forth in claim 13, wherein:
the business establishment comprises a restaurant; and
said multitude of selectively changeable icons comprise icons of various different food items to be prepared within the restaurant in accordance with food menu item orders placed by food patrons of the restaurant.

15. The system as set forth in claim 14, wherein:
said multitude of selectively changeable icons indicative of various different food items to be utilized within foods to be prepared comprise pictures of fried eggs, scrambled eggs, cucumbers, sliced limes, shredded lettuce, grated parmesan cheese, smoked gouda cheese, mixed salads, cream cheese, Swiss cheese, hamburgers, mozzarella cheese, leaf lettuce, American cheese, pepper cheese, slivered onions, cheddar jack cheese, sliced tomatoes, diced pineapples, California cheese, broccoli, milk, cream, potatoes for French fries, chicken strips, chicken tenders, Canadian bacon, sausage, mustard, ketchup, other sauces, fish filets, fountain drinks, coffee, whipped cream, pancake batter, and the like.

16. The system as set forth in claim 15, wherein:
said multitude of selectively changeable icons indicative of various different food items to be utilized within foods to be prepared comprise time icons within which time periods the food items are to be prepared.

17. The system as set forth in claim 15, wherein:
said multitude of selectively changeable icons indicative of various different food items to be utilized within foods to be prepared comprise time icons within which time periods the food items are to be utilized so as to ensure freshly prepared food items for the patrons.

18. The system as set forth in claim 15, wherein:
said multitude of selectively changeable icons indicative of various different food items to be utilized within foods to be prepared comprise time icons within which time periods the food items are to be stored under refrigerated conditions so as to ensure freshly prepared food items for the patrons.

19. The system as set forth in claim 13, wherein:
said multitude of selectively changeable icons comprise icons of various different operational procedures to be performed within the business establishment in accordance so as to ensure that the business establishment runs properly and efficiently.

20. The system as set forth in claim 19, wherein:
said multitude of selectively changeable icons comprising icons of various different operational procedures to be performed within the business establishment in accordance so as to ensure that the business establishment runs properly and efficiently is selected from the group comprising the cleaning of utensils, cleaning of tables, discarding trash, food preparation personnel washing their hands or changing gloves within which they handle food items, and the like.
